(19) United States
(12) Patent Application Publication
(10) Pub. No.: US 2007/0241635 A1
(43) Pub. Date: Oct. 18, 2007

(54) Apparatus Comprising a Thermal Bimorph with Enhanced Sensitivity

(75) Inventors: Scott R. Hunter, Oak Ridge, TN (US); Gregory Simelgor, Ithaca, NY (US)

Correspondence Address: DEMONT & BREYER, LLC, 100 COMMONS WAY, HOLMDEL, NJ, 07733, US

(73) Assignee: Multispectral Imaging, Inc.

(21) Appl. No.: 11/279,954

(22) Filed: Apr. 17, 2006

(51) Int. Cl. H02N 10/00

(52) U.S. Cl. 310/307; 310/306

(57) ABSTRACT

A thermal bimorph that exhibits improved layer adhesion and an enhanced bending response is disclosed. The thermal bimorph incorporates corrugations that extend fully through the bimorph to its two major surfaces. In some embodiments, the thermal bimorph is asymmetrically corrugated.

### FIELD OF THE INVENTION

The present invention relates to structures that exhibit the thermal bimorph effect, and devices that incorporate such structures.

### BACKGROUND OF THE INVENTION

Thermal bimorphs are structures, typically multi-layered, which exhibit a thermally-induced bending response. The bending response results from stresses in the structure. The stresses arise when, in response to thermal changes, at least two of the layers within the structure expand or contract by differing amounts. This differential expansion is usually caused by layer-to-layer variations in the thermal expansion coefficient (“TEC”). When heated, the structure bends in the direction of the layer with the lower TEC.

Thermal bimorphs are frequently used as actuators, especially for MEMS technology applications. In a typical actuator implementation, electric current is applied to the bimorph actuator, which causes it to heat up and bend. The bending movement is used to change the position of another element (e.g., moving a mirror into or out of the path of an optical signal, etc.). MEMS-based thermal-bimorph actuators have been used in many applications, a few of which include:
actuators for passive electrical components (e.g., tunable RF MEMS inductors for wireless applications, etc.);
actuators for scanning mirrors (e.g., optical displays, biomedical imaging, laser beam steering, optical switching, wave-front shaping in adaptive optics, interferometry systems, spatial light modulators, tunable lenses for confocal microscopy, actuators on magnetic recording heads, precision micro-positioning systems, and optical coherence tomographic (OCT) imaging systems, etc.); and
actuators for fluidic applications (e.g., micro-machined valve actuators, fluid diverters, etc.).

Thermal bimorphs have also been used as sensors. Perhaps the most familiar implementation is the bimetallic strip within a thermostat. One particularly important MEMS sensor application is radiant-energy sensing, such as infrared radiation (“IR”) sensing.

In a typical IR-sensor application, a paddle or plate is supported above a substrate by thermal-bimorph support arms. At least a portion of the plate and the underlying substrate are electrically conductive, thereby serving as electrodes. The electrodes collectively define a “sensing capacitor,” the capacitance of which is a function of the electrodes' separation distance. Typically, a plurality of sensing capacitors are arranged in an array and disposed at the focal point of a lens, thereby defining the familiar “focal plane array.”

In operation, the plate of each sensing capacitor receives infrared radiation and heats up. The heat is conducted to the support arms, which bend due to the thermal bimorph effect. As the support arms bend, the plate moves up or down (depending on the design). Movement of the plate alters the spacing between the electrodes, thereby causing a change in the capacitance of the sensing capacitor. In this fashion, radiation that is incident on the plate is sensed as a change in capacitance. The change in capacitance is captured by read-out electronics and can be quantified and interpreted to provide an image, such as in an IR camera. (See, e.g., U.S. Pat. No. 6,118,124, etc.).

Notwithstanding their widespread use, thermal bimorphs do have some drawbacks. One drawback arises from their very nature. That is, to the extent that layers within a multi-layer structure have differing thermal expansion coefficients to create the thermal bimorph effect, those layers are typically constituted from different materials. And that gives rise to incompatibility issues; in particular, inter-layer adhesion problems. To address this problem, one or more transitional layers are often sandwiched between the primary bimorph layers. The transitional layer(s) comprise materials that are relatively more compatible with the primary bimorph layers than the primary layers are with each other. This disadvantageously complicates the fabrication process and increases costs.

A second drawback of thermal bimorphs pertains to their use as actuators. In particular, thermal bimorph actuators dissipate more power than electrostatic actuators for a comparable amount of actuation.

### SUMMARY OF THE INVENTION

The present invention provides a thermal bimorph that exhibits improved layer adhesion and an unexpected but quite advantageous enhancement in bending response relative to the prior art. The enhanced bending response translates as increased sensitivity in thermal-bimorph-based sensors and decreased power requirements in thermal-bimorph-based actuators.

The enhanced performance of thermal bimorphs disclosed herein and devices that incorporate them arise from the presence of “corrugations” in the thermal bimorph. The corrugations, which appear in at least a portion of the thermal bimorph, extend fully through the thermal bimorph. In other words, the two major surfaces of the thermal bimorph (e.g., the two main surfaces of a beam, etc.) exhibit the characteristic ridges and trenches of the corrugations.

The inventor's intent in corrugating a thermal bimorph was to improve the adhesion between its dissimilar layers. And, in fact, corrugated thermal bimorphs disclosed herein do exhibit improved layer adhesion. But they also exhibit an unanticipated enhancement in thermal responsiveness. The enhancement is believed to be due to at least two factors. They are:
Corrugating a thermal bimorph permits an increase in its length, which results in a greater bending response. Corrugations have the effect of increasing the actual length of a beam, etc., (i.e., increasing its surface) without increasing its end-to-end length. Consider two thermal bimorphs having the same end-to-end length, one corrugated and the other not. If the corrugated thermal bimorph were stretched flat, it would be longer than the non-corrugated bimorph. A relatively longer thermal bimorph will exhibit a larger change in length in response to thermal variations than a relatively shorter one. As a consequence, the relatively longer thermal bimorph will have a greater bending response than a relatively shorter one for a given change in temperature.
The presence of the corrugations reduces the stiffness of a thermal bimorph in the direction of deflection. Since the stiffness is reduced, a greater deflection is obtained for a given change in temperature.
   A further benefit of corrugating a region of a thermal bimorph is that bending movement can be substantially restricted to that region.

In some embodiments, the size of the ridges and the size of the trenches of the corrugations are different. The result is an asymmetrically-corrugated thermal bimorph, wherein the two major surfaces of the bimorph have different profiles. Experimentation has shown that the asymmetrically-corrugated thermal bimorphs disclosed herein exhibit a 200 to 300 percent increase in bending responsiveness (amount of bending per degree change in temperature) compared to thermal bimorphs in the prior art.

In some other embodiments, the size of ridges and the size of the trenches of the corrugations are identical, resulting in a symmetrically-corrugated thermal bimorph. Although not quite as responsive as asymmetrically-corrugated thermal bimorphs, the symmetrically-corrugated thermal bimorphs disclosed herein exhibit superior bending response compared to the prior-art.

The illustrative embodiment of the present invention is a sensor array comprising a plurality of micro-mechanical capacitive sensors. The sensors have support arms that incorporate a corrugated thermal bimorph, as disclosed herein. The sensors are responsive to radiant energy, such as infrared radiation, and can serve as a focal plane array for an IR camera.

It is to be understood that the corrugated thermal bimorphs disclosed herein can be used in conjunction with other types of structures and for other applications to provide a wide variety of sensors and actuators.

### BRIEF DESCRIPTION OF THE DRAWINGS

FIG. 1 depicts an IR camera, wherein the IR camera incorporates a sensor array of IR sensors having corrugated, thermal-bimorph support arms in accordance with the illustrative embodiment of the present invention.

FIG. 2 depicts further detail of the sensor array of FIG. 1.

FIG. 3A depicts a plan view of a sensor of the sensor array of FIG. 2.

FIG. 3B depicts a side view of the sensor of FIG. 3A, wherein the sensor's plate is in a quiescent position prior to receiving radiant energy.

FIG. 3C depicts a side view of the sensor of FIG. 3A, wherein the sensor's plate has moved a distance, Δz, in response to receiving radiant energy.

FIG. 4A depicts an asymmetrically-corrugated thermal-bimorph in accordance an embodiment of the present invention.

FIGS. 4B through 4I depict variations of the asymmetrically-corrugated thermal-bimorph that is depicted in FIG. 4A

FIG. 5 depicts the bending response sensitivity of a straight, cantilevered, thermal bimorph as a function of Young's modulus for several layer thicknesses.

FIG. 6 depicts the bending response sensitivity of a straight, cantilevered, thermal bimorph as a function of layer thickness for several values of Young's modulus.

FIG. 7 depicts a variation of the asymmetrically-corrugated thermal bimorph shown in FIG. 4A, wherein the corrugations are symmetric.

FIG. 8 depicts a corrugated, thermal-bimorph used as an actuator.

### DETAILED DESCRIPTION

The following terms are defined for use in this Specification, including the appended claims:
Physically-coupled means direct, physical contact between two objects (e.g., two surfaces that abut one another, etc.).
Mechanically-coupled means that two or more objects interact with one another such that movement of one of the objects affects the other object. For example, consider an actuator and a platform. When triggered, the actuator causes the platform to move. The actuator and the platform are therefore considered to be “mechanically-coupled.” Mechanically-coupled devices can be, but are not necessarily, physically coupled. In particular, two devices that interact with each other through an intermediate medium are considered to be mechanically coupled. Continuing with the example of the platform and the actuator, if the platform supports a load such that the load moves when the platform moves (due to the actuator), then the actuator and the load are considered to be mechanically coupled as well.
Electrically-coupled means that two objects are in electrical contact. This can be via direct physical contact (e.g., a plug in an electrical outlet, etc.), via an electrically-conductive intermediate (e.g., a wire or conductive trace that connects devices, etc.), or via intermediate devices, etc. (e.g., a resistor electrically connected between two other electrical devices, etc.).
Operatively-coupled means that the operation of one object affects another object. For example, consider an actuator that is actuated by electrical current, wherein the current is provided by a current source. The current source and the actuator are considered to be “operatively-coupled” (as well as “electrically coupled”). Operatively-coupled devices can be coupled through any medium (e.g., semiconductor, air, vacuum, water, copper, optical fiber, etc.) and involve any type of force. Consequently, operatively-coupled objects can be electrically-coupled, hydraulically-coupled, magnetically-coupled, mechanically-coupled, optically-coupled, pneumatically-coupled, thermally-coupled, etc.
Thermal Bimorph means a structure (e.g., beam, etc.) that exhibits thermal bimorph behavior (i.e., thermally-induced bending response). Thermal bimorph behavior can be created in single-layer (single material) structures, bi-layer (bi-material) structures, or in structures that have more than two layers comprising two or more materials. In other words, notwithstanding the prefix “bi,” a thermal bimorph can have more or less than two discrete layers comprising more or less than two different materials.
Corrugations means a series of alternating ridges and trenches, wherein one ridge and one trench collectively define a “corrugation.”
   Other terms will be defined, as appropriate, throughout this specification.

As indicated in the Summary section, the present invention provides a corrugated thermal bimorph for use as or in micromechanical sensors and actuators. In the illustrative embodiment of the invention, the corrugated thermal bimorph is embodied as a portion of a support arm of an IR sensor in an array of such sensors.

It is to be understood that the illustrative embodiment is not intended as a limitation; rather, it is intended to provide context for the invention and is simply one of many possible embodiments thereof. In fact, the corrugated thermal bimorphs disclosed herein can be used to provide a variety of different types of sensing or actuating elements. For example, the corrugated thermal bimorphs disclosed herein can be used to enhance the performance of any of the conventional thermal-bimorph actuators mentioned in the Background section.

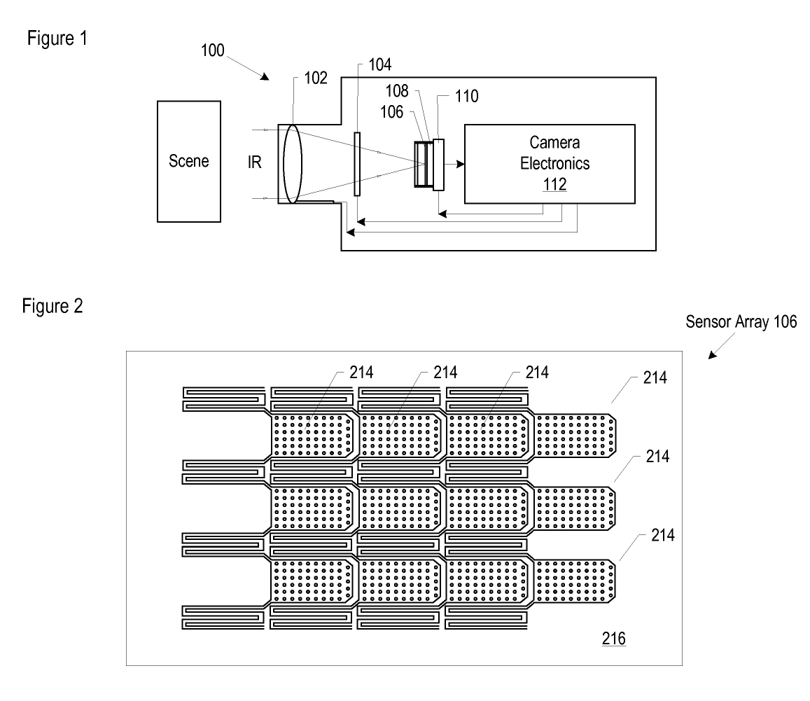

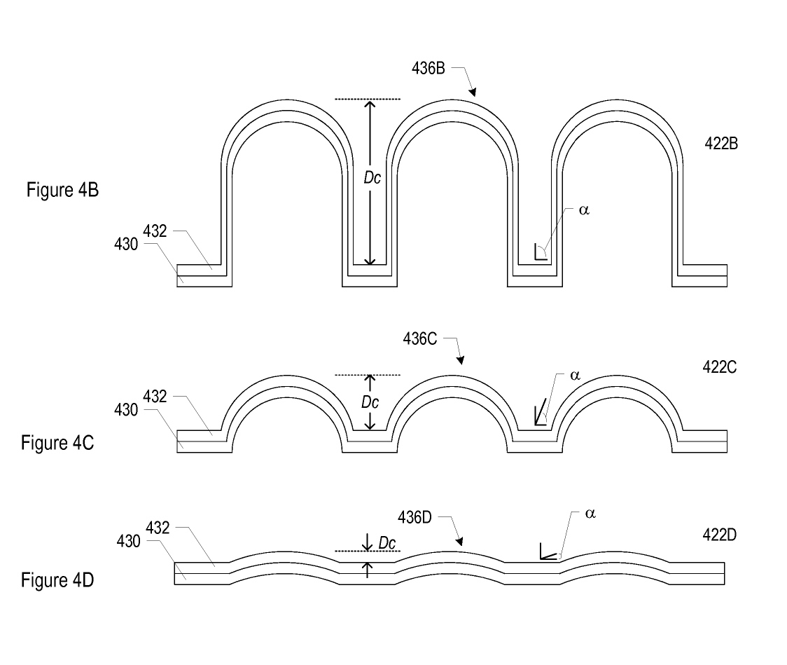

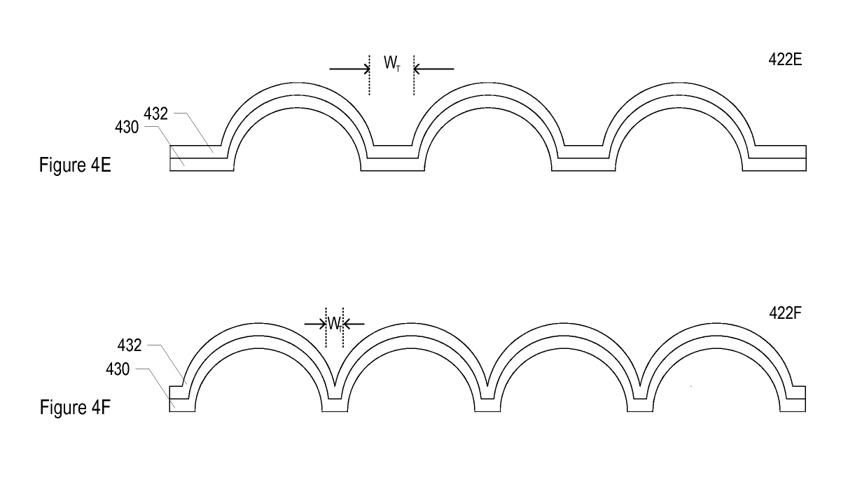

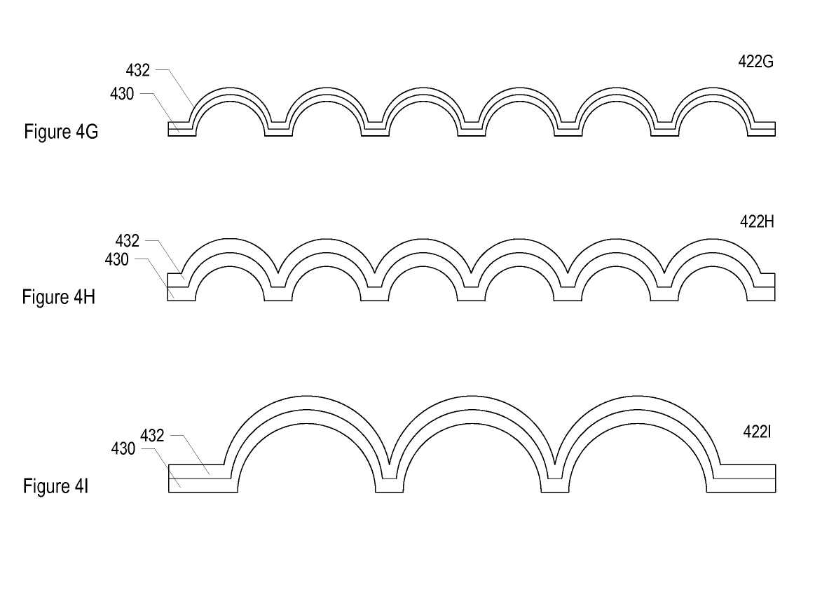

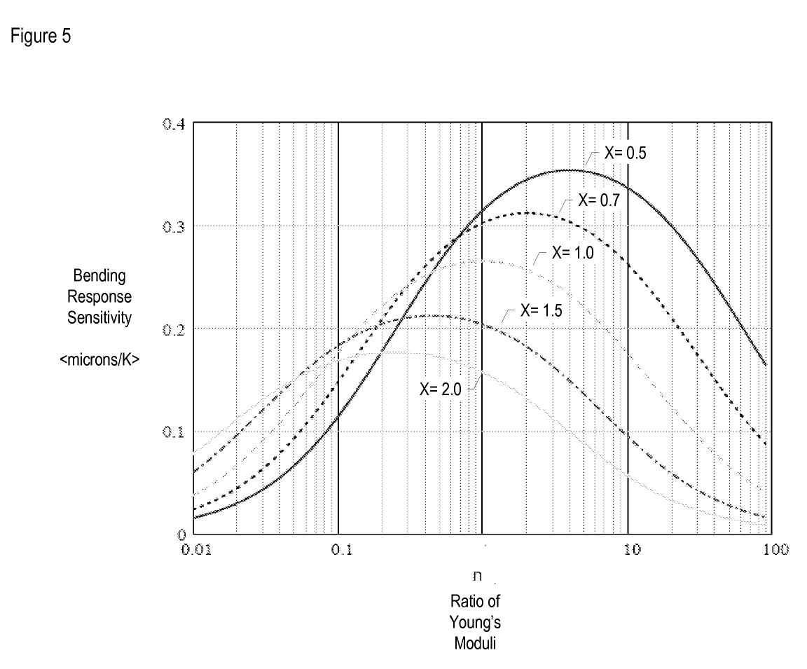

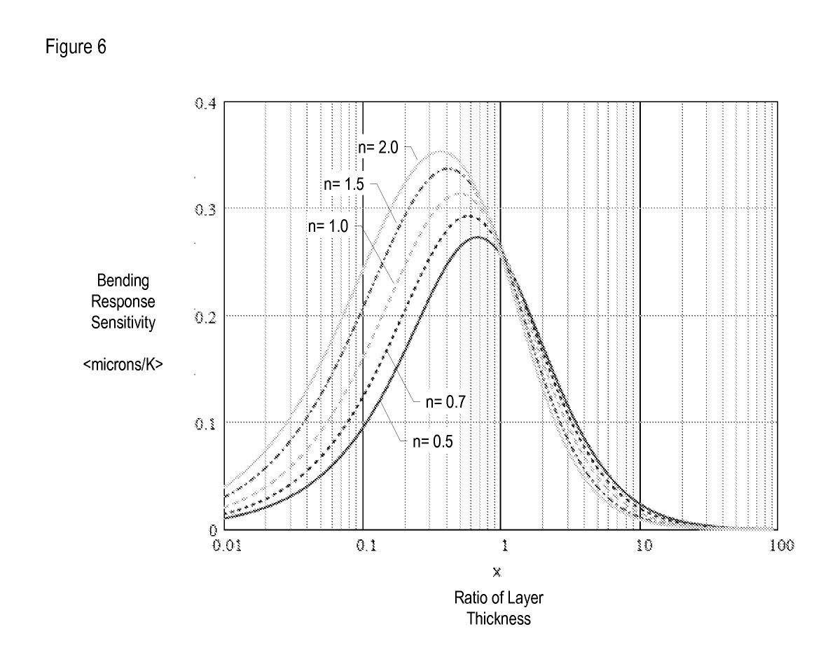

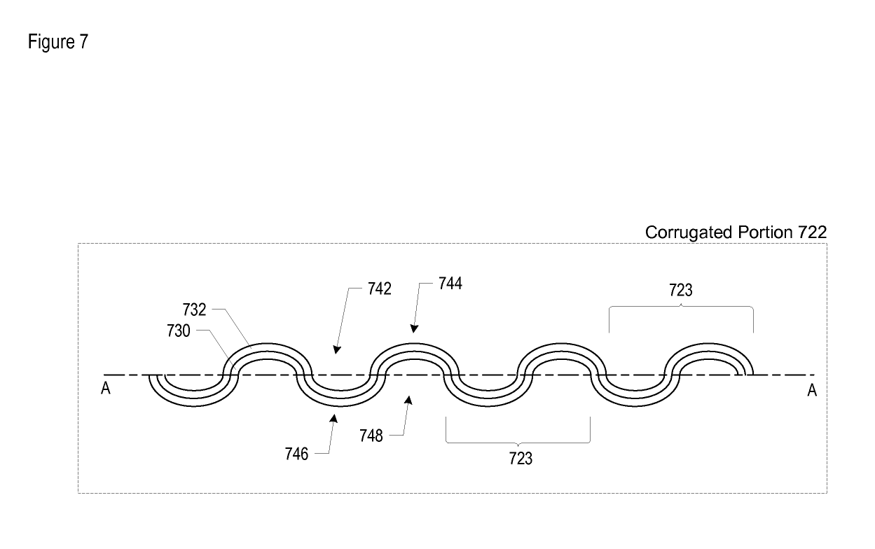

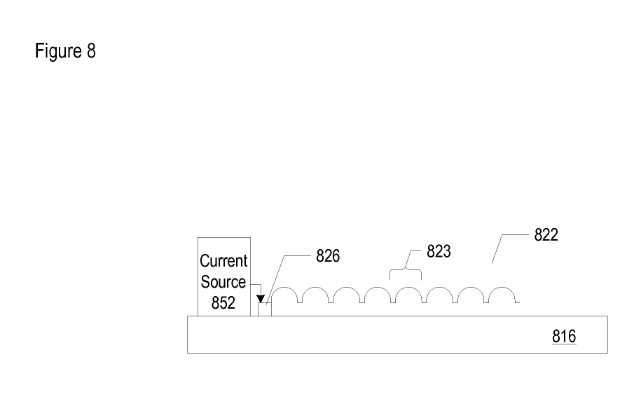

To provide context for the invention, this Detailed Description begins with a discussion of the illustrative embodiment of the invention, which is a sensor array that comprises corrugated thermal-bimorph-based sensing elements. Disclosure concerning the use of the sensor array in an IR camera, the individual sensors in the array, and the operation of the sensors is provided in conjunction with FIGS. 1, 2, and 3A-3C. The disclosure then continues with a description of an asymmetrically-corrugated thermal bimorph, such as can be used to the form the support arms of the IR sensor in the sensor array. FIGS. 4A through 4I depict various embodiments of asymmetrically-corrugated thermal bimorphs and the accompanying description provides considerations for enhancing their performance. FIGS. 5 and 6 pertain to the design and optimization of thermal bimorphs. Finally, a description of some alternative embodiments, including both structural and operational variations, is provided in conjunction with FIGS. 7 and 8.

### The Illustrative Embodiment

FIG. 1 depicts the salient elements of IR camera 100, including IR imaging optics 102, shutter 104, sensor array 106, read-out integrated circuit 108, temperature stabilizer 110, and camera electronics 112, interrelated as shown.

IR imaging optics 102 include one or more lenses that receive radiant energy, such as infrared radiation. IR radiation that is received by IR imaging optics 102 is directed toward shutter 104. The shutter controls the amount of radiation that is directed toward sensor array 106. Those skilled in the art will know how to make, specify, and use IR imaging optics 102 and shutter 104.

Sensor array 106 receives the radiant energy that is captured by IR imaging optics 102 and admitted by shutter 104. Sensor array 106 is located at the focal point of IR imaging optics 102 and is, therefore, properly termed a “focal plane array.” As described later in this specification, sensor array 106 comprises an array of micromechanical capacitive sensors that respond to IR. These sensors have support arms that incorporate a corrugated thermal bimorph, in accordance with the illustrative embodiment of the present invention.

In response to the received radiation, the capacitance of the various sensors of sensor array 106 changes. These capacitances are “read” or “extracted” by read-out integrated circuit (“ROIC”) 108, in known fashion. The ROIC generates voltage signals that are indicative of the extracted capacitances. ROIC 108 performs various other functions as well, including signal conditioning and amplification. Those skilled in the art will know how to use ROIC 108 to extract the capacitance of the various sensors in sensor array 106 and provide a voltage signal indicative thereof.

Temperature stabilizer 110 ensures that sensor array 106 is thermally isolated from its environment, other than from the received IR. Camera electronics 112 includes various amplification, offset, and gain-control electronics, multiplexing and A-to-D circuitry, a camera-control microprocessor, various external control electronics, digital read-out and the like. In a nutshell, camera electronics 112 receives the voltage signals from ROIC 108 and processes the signals into an image. Camera electronics 112 also control the focus of IR imaging optics 102 and control shutter 104 and temperature stabilizer 110. Those skilled in the art will be familiar with the design and use of the various devices and circuits that compose camera electronics 112 and know how to integrate sensor array 106 therewith.

FIG. 2 depicts a plan view of a portion of sensor array 106. The sensor array comprises a plurality of closely-spaced capacitance sensors 214, each of which defines a “pixel” of the array. Only a few (twelve) sensors 214 are depicted in array 106. Array 106 would typically be implemented as a much larger array, such as a 160×120 pixel array, which includes 19,200 sensors 214. Since individual sensors 214 are micron-sized, the array is formed via standard micromachining techniques. In some alternative embodiments (not depicted), the array is a linear array wherein sensors 214 are linearly arranged.

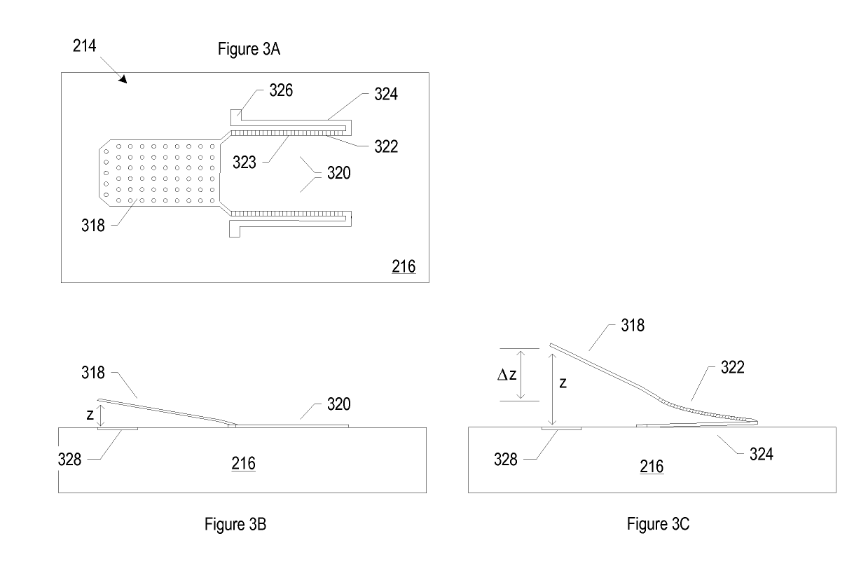

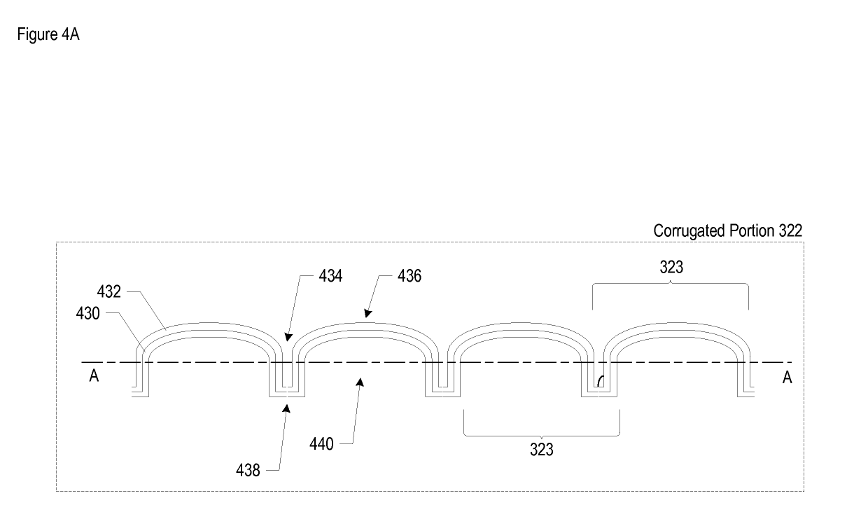

FIGS. 3A (plan view) and 3B (side view) depict sensor 214 in a quiescent mode (i.e., not receiving radiation). The sensor includes cantilevered plate 318, which is suspended above substrate 216 by two “folded” support arms 320. The support arms are anchored to substrate 216 at anchors 326.

As depicted in FIG. 3B, plate 318 is disposed a distance z above electrode 328 when in the quiescent mode. Plate 318 serves as an absorber of radiant energy and also as an electrode. In some embodiments, plate 318 comprises an overlying layer of titanium nitride and at least two underlying layers, one of silicon dioxide and another comprising siliconoxynitride. The holes that are present in plate 318 (see, e.g., FIG. 3A) serve a manufacturing purpose. In particular, the holes deliver etchant to sacrificial material that underlies plate 318. The etchant selectively etches the sacrificial material, thereby releasing the plate from underlying substrate 216. In some embodiments, plate 318 also includes ribs (not shown), which add structural rigidity.

Regarding the plate's function as a radiant-energy absorber, the region between plate 318 and substrate 216 forms a resonant cavity that enhances the absorption of radiation in the range of interest. For example, in some embodiments, the separation distance z is selected to provide a resonant cavity for long wave IR (i.e., 7.5 to 14 micron wavelength). IR absorption is provided by the materials that compose plate 318 as well. The titanium nitride layer serves as an impedance matching layer to match the free space impedance of the resonant cavity. The titanium nitride layer also imparts electrical conductivity, which is required for plate 318 to serve as a capacitive element.

Support arms 320 comprise two portions 322 and 324. Portion 322, which is nearest to plate 318, comprises a thermal bimorph that includes corrugations 323 in accordance with the present teachings. In some embodiments, portion 322 includes a layer of metal, such as aluminum, disposed beneath a dielectric layer(s), such as silicon dioxide and/or siliconoxynitride and/or silicon nitride. Since the metal layer, which has the relatively higher TEC, is located beneath the dielectric layer, which has the relatively lower TEC, portion 322 will bend “upwards” (i.e., away from substrate 216) in response to heating. Upward bending is advantageous because it improves dynamic range, since greater range of movement is permitted. Also, upward movement decreases the likelihood of inadvertent contact with the substrate, which is likely to result in stiction (i.e., permanent attachment of the movable element to the substrate). Of course, the material layers can be inverted (i.e., layer with the lower TEC beneath the layer with the higher TEC) to provide downward bending upon heating, if desired.

Portion 324, which couples to anchor 326, presents a thermal resistance to the transfer of heat out of portion 322 towards substrate 216. The entirety of each support arm 320 is electrically conductive to electrically couple plate 318 to ROIC 108, etc.

FIG. 3C depicts sensor 214 after it has absorbed IR. As shown, the separation z between plate 318 and electrode 328 has increased by the distance Δz. This increase in separation distance is a consequence of the response of portion 322 to the heat from the absorbed radiation. More particularly, the radiation absorbed at plate 318 is converted to heat and conducted to portion 322 of support arms 320. Due to the thermal bimorph effect, portion 322 bends. The bending effect of portion 322 is enhanced due to corrugations 323.

Asymmetrically-Corrugated Thermal Bimorph For Use in Conjunction with Sensors and Actuators

FIG. 4A depicts further detail of portion 322 of support arm 320. As depicted in FIG. 4A, portion 322 comprises two layers 430 and 432. To provide the desired bending response (i.e., upward bending in response to heating), lower layer 430 comprises a material with a relatively higher TEC and upper layer 432 comprises a material with a relatively lower TEC. In some embodiments, lower layer 430 comprises a material that has a TEC that is at least about 10.×10⁻⁶ K⁻¹ and upper layer 432 comprises a material that has a TEC that is less than about 10.×10⁻⁶ K⁻¹.

In some embodiments, the material with the relatively higher TEC is a metal, such as, without limitation, aluminum, gold, silver, lead, cadmium, manganese, zinc, tantalum, and lanthanum. In some embodiments, the material with the relatively lower TEC is a dielectric, such as, without limitation, a silicon oxide, silicon oxynitride, other low TEC oxides of silicon, silicon nitride, amorphous silicon carbide, amorphous hydrogenated silicon carbide, and amorphous silicon.

It will be appreciated by those skilled in the art that any of a wide variety of materials can be selected, as a function of application specifics, to provide the relatively-lower and relatively-higher TEC layers of a thermal bimorph in accordance with the illustrative embodiment of the present invention. For example, the material having the relatively higher TEC does not need to be limited to metals. In particular, high TEC plastics and polymeric materials can be used. A non-limiting list of examples of such non-metallics include: polycarbonate, polypropylene, polyethylene, Teflon, nylon, Lucite, polyamide, and various photoresists.

As previously indicated, if desired, a downward bending response is readily created by simply reversing layers 430 and 432; that is, situating the layer having the relatively-lower TEC beneath the layer having the relatively-higher TEC.

Portion 322 is an asymmetrically-corrugated thermal bimorph; that is, it comprises a plurality of asymmetric corrugations 323. Each corrugation includes a ridge and trench. As viewed from the “upper” surface of portion 322 (the surface above plane A-A), each corrugation 323 comprises trench 434 and ridge 436. As viewed from the “lower” surface of portion 322 (the surface below plane A-A), each corrugation 323 comprises ridge 438 and trench 440. It is apparent that ridge 438 and trench 434 are simply opposite sides of the same feature. Likewise for ridge 436 and trench 440.

The thermal bimorph depicted in FIG. 4A is asymmetric about plane A-A. That is, the upper and lower surfaces of portion 322 have different profiles. This is a consequence of the fact that the ridges and trenches are not the same size.

This asymmetry between the upper and lower surfaces enhances the bimorph's bending response. Without being limited to any particular theory, mechanism, or understanding, the reason for this enhancement is believed to be due to a difference in bending radius between the upper and lower surfaces of the asymmetrically-corrugated thermal bimorph.

In particular, with regard to portion 322 in FIG. 4A, the bends that are formed in the lower surface (i.e., the transitions between ridges 446 and trenches 448) are substantially at right angles, defining a very small radius of curvature. On the other hand, the bends in upper surface (i.e., the transitions between ridges 444 and trenches 442) are much less severe and define a much larger radius of curvature. It is believed that the relatively smaller radius of curvature of the lower surface results in relatively greater stresses than the relatively larger radius of curvature of the upper surface.

In the corrugated thermal bimorph that is shown in FIG. 4A, layer 430 comprising relatively higher TEC material is disposed beneath layer 432 comprising relatively lower TEC material. As a consequence, stresses due to the greater expansion of the lower layer (under heating) combine additively with the stresses due to smaller radius of curvature of the lower surface to enhance the stress differential between the layers. This results in a substantially enhanced bending response.

FIGS. 4B through 4I depict variations of the asymmetrically-corrugated thermal bimorph 322 that is depicted in FIG. 4A. These figures, and the accompanying description, provide a qualitative analysis of the bending response of an asymmetrically-corrugated thermal bimorph for variations in certain structural aspects of the asymmetrically-corrugated thermal bimorphs. In particular, the effects of changes in corrugation depth D_{c}, trench bend angle α, radius of curvature of the corrugation, and number of corrugations are described.

FIGS. 4B through 4D depicts asymmetrically-corrugated thermal bimorphs 422B through 422D. Of these three thermal bimorphs, bimorph 422B has the greatest corrugation depth D_{c} and bimorph 422D has the shallowest corrugation depth. Bimorph 422C has a corrugation depth D_{c}, that is intermediate between that of bimorphs 422B and 422D. The greater the corrugation depth D_{c}, the greater the bending effect, since this effectively increases the length of the bimorph.

Of the three thermal bimorphs depicted in FIGS. 4B through 4D, bimorph 422B depicts the greatest bend angle α (ninety degrees), bimorph 422C depicts a somewhat lower bend angle α (about seventy degrees), and bimorph 422D depicts the smallest bend angle α (less than about twenty degrees). Bending response increases as trench bend angle α increases from 0 degrees to 90 degrees (as long as the material with the higher TEC is the lower layer). As a consequence, thermal bimorph 422B will exhibit the largest enhancement in bending response due to the trench bend angle factor and thermal bimorph 422D will exhibit the smallest enhancement in bending response due to this factor. Trench bend angles greater than 90 degrees are not practical to achieve and are not expected to improve bending responsiveness.

Unlike thermal bimorph 322 depicted in FIG. 4A, the thermal bimorphs shown in FIGS. 4B through 4D have corrugations in which the ridges 436B, 436C, and 436D exhibit a constant radius of curvature (excluding, in FIG. 4B, the portion of each ridge that defines the vertical sidewalls of the trench). A ridge have a constant radius of curvature is expected to enhance the bending response as compared to a ridge that has a radius of curvature that varies, as in FIG. 4A.

It is clear that thermal bimorph 422B will exhibit the greatest enhancement in bending response due to the confluence of the various factors described above. In particular, thermal bimorph 422B has the greatest corrugation depth D_{c} and the maximum trench bend angle.

Bending response is increased by increasing the total effective length of a thermal bimorph. As a consequence, bending response is enhanced by increasing the number of corrugations per unit length of bimorph. One way to do this is minimize the width W_{T} of the trenches, as illustrated via FIGS. 4E and 4F. The bimorph structure depicted in FIG. 4F is optimum (for this factor) since trench width W_{T} is at a practical minimum. On the other hand, bimorph 422E in FIG. 4E is a sub-optimum structure since its relatively larger trench width results in fewer corrugations per unit length of the bimorph. In this regard, note how the larger trench width of bimorph 422E permits only three corrugations to the four corrugations of bimorph 422F for the same unit length.

In practice, the trench must have some minimum width, which is determined by the photolithography and materials deposition tools being used to fabricate the asymmetrically-corrugated thermal bimorph.

Another approach for enhancing the bending response by increasing total effective length of the thermal bimorph is to reduce the radius of curvature of each ridge. This will, of course, increase the number of trenches and ridges per unit length of the thermal bimorph. Compare, for example, bimorph 422G of FIG. 4G to bimorphs 422H and 422I of FIGS. 4H and 4I. It is noted, however, that if the radius of curvature of the ridges is too small, this will counter the enhancing effect of a large (i.e., ninety degrees) trench bend angle.

Theoretically, consideration of factors such as the number of trenches, the radius of curvature of the ridges, and the thicknesses of the (two) layers that compose the bimorph will define an optimum bending response. It is expected that a local optimum bending response will be exhibited for thermal bimorphs in which the ratio of the radius of curvature of the ridge to the total bimorph layer thickness is within a range of about 1 to 10. By way of illustration, bimorph 422G of FIG. 4G has a higher value for this ratio than bimorph 422H of FIG. 4H (these two bimorphs have the same radius of curvature but bimorph 422H has is thicker).

As is evident from Expression [1], which is presented later in this specification, bending response is enhanced as layer thickness is decreased (layer thickness appears in the denominator of that expression). Thus, bending response depends on absolute layer thickness, not simply the ratio mentioned above. As a consequence, bimorph 422G with relatively thinner layers will exhibit a greater bending response than bimorph 422H with relatively thicker layers, even though the bimorphs have the same number of ridges and trenches with the same radius of curvature and the same trench depth.

It is notable that while the asymmetrically-corrugated thermal bimorph depicted in FIGS. 4A-4I have two layers 430 and 432, in some other embodiments, more layers are present. Furthermore, in some other embodiments, only a single layer is present. A thermal-bimorph-type effect can be created in a single layer by creating a difference in the heat transfer from its two major surfaces. This can be accomplished, for example, by placing the surfaces in contact with different types of fluids that have substantially different heat transfer coefficients (e.g., a liquid versus a gas, etc.).

To realize an enhanced bending response, it is important that the corrugations appear on both major surfaces (e.g., of a beam, etc.) of a thermal bimorph. For the purposes of this specification and the appended claims, a thermal bimorph that possesses corrugations on one major surface but not on the other is not considered to be “asymmetrically corrugated” nor even “corrugated.” Even though that configuration would define an asymmetric structure, it does not meet the requirement of the corrugations extending to both major surfaces of a thermal bimorph. Again, corrugations must appear on both sides of the thermal bimorph element to be considered “corrugated,” as this term is used herein.

On the other hand, in some embodiments, a corrugated thermal bimorph in accordance with the present invention will be embedded in a member having planar exterior surfaces. As long as the planar layers are functionally discrete and incidental to the corrugated thermal bimorph such that they do not contribute, in any significant way, to the bending response of the member, such an arrangement is contemplated to be within the scope of the present invention.

To design a sensor or actuator that incorporates a corrugated thermal bimorph as disclosed herein, the bending response (i.e., movement per degree of temperature change) of the bimorph must be known. Expressions [1] through [3] below provide the bending response of a thermal bimorph. These expressions apply to both thermal-bimorph sensors and actuators since the expressions are general for any mode of heating (i.e., radiation, conduction, or convection).

It is notable that Expressions [1] through [3] below are valid for an non-corrugated, straight, cantilevered-beam thermal bimorph. Since this specification marks the first disclosure of a corrugated thermal bimorph, equations similar to expressions [1] through [3] for the corrugated thermal bimorphs disclosed herein have yet to be developed. Nevertheless, expressions [1] through [3], and FIGS. 5 and 6 based thereon, should be used to as a starting point for the design and optimization of devices that incorporate the corrugated thermal bimorphs disclosed herein.

The deflection or change in separation distance, Δz, of the tip of cantilevered plate 318 when sensor temperature increases from Tₒ to T due to the bending of a thermal bimorph is given by:
Δz=(3Lₚ²/8t_{H})(α_{H}−α_{L})(T−Tₒ)Kₒ [1]

Where: Lₚ is the length of thermal bimorph;
t_{H} is the thickness of the layer with the higher CTE;

α_{H} is the CTE of the material with the higher CTE;
α_{L} is the CTE of the material with the lower CTE;
(T−Tₒ) is the absolute temperature differential; and
Kₒ is a constant, as given by expression [2], below.
   Kₒ=8(1+x)/(4+6x+4x²+nx³+1/nx) [2]

Where: x is the “thickness” ratio, t_{L}/t_{H};
t_{L} is the thickness of the layer with the lower CTE;
n is the Young's moduli ratio, E_{L}/E_{H};
E_{L} is Young's modulus of the material with the lower CTE; and
E_{H} is Young's modulus of the material with the higher CTE.

The “bending-response sensitivity” of cantilevered plate 318 is then given by:
R=Δz/(T−Tₒ) [3]

Where: R is in units of microns of movement per degree Kelvin change in temperature.

Note that the bending-response sensitivity R is different than “voltage responsivity Rᵥ,” which is the normal measure of IR-sensor responsiveness. For comparison, voltage responsivity has units “volts/Kelvin” and is determined by the expression:
Rᵥ=(VₛCₛ/C_{T}Z_{gap})×(Δz/(T−Tₒ)) [4]

Where: Vs is the applied sensing voltage;
Cs is the capacitance of the microcantilever capacitive sensor;
C_{T} is the total capacitance of the sensor, including the microcantilever sensor, reference capacitor, preamplifier input capacitance and any parasitic capacitances; and
Zgap is the effective plate separation of the microcantilever sensor capacitor.

Expressions [1] through [3] were used to develop plots, which are depicted in FIGS. 5 and 6, which show the effects of changes in layer thickness and Young's modulus on the bending response of the thermal bimorph. The plots are based on a representative cantilevered thermal bimorph, which is characterized as follows:

Lₚ (length of thermal bimorph)=50.0 microns

t_{H} (thickness of the layer with the higher CTE)=0.3 microns

t_{L} (thickness of the layer with the lower CTE)=0.1 microns

α_{H} (CTE of the material with the higher CTE)=2.31×10⁻⁵ K⁻¹

α_{L} (CTE of the material with the lower CTE)=7×10⁻⁷ K⁻¹

x (“thickness” ratio, t_{L}/t_{H})=Varied

n (Young's moduli ratio, E_{L}/E_{H})=Varied

The plots that are provided in FIGS. 5 and 6 are specific to the representative thermal bimorph defined above, but do provide an illustration of how expressions [1] through [3] can be used to provide information that is necessary for the design and optimization of a device that incorporates the corrugated thermal bimorphs described herein.

Turning now to the plots, FIG. 5 depicts bending response sensitivity, R, of a corrugated, thermal-bimorph member (as characterized above) as a function of n for several values of x. The parameter n is the ratio of Young's moduli for layers of the bimorph and the parameter x is the ratio of the thickness of the layers of the bimorph. (See, expression [2] for further details regarding these parameters.)

As shown in FIG. 5, for n less than about 0.1, bending response sensitivity increases with an increase in x, but is still relatively low. In other words, for the two-layer bimorph described above, bending sensitivity increases as the ratio of the upper layer thickness to the lower layer thickness increases (e.g., from x=0.5 to x=2.0). Bending sensitivity is, however, below its maximum for all values of x in this region.

The behavior observed for n<0.1 transitions toward a different behavior in the region: 0.1<n<0.7. The maximum bending response sensitivity for x≧about 1.3 is predicted to be in this region. In particular, for x=1.5, a maximum bending sensitivity of about 0.215 microns/K is predicted for n in the range of about 0.4 to about 0.5. Also, for x=2.0, a maximum sensitivity of about 0.175 microns/K is predicted for n equal to about 0.2.

For n>0.7, the new bending-response-sensitivity trend is established, which is the opposite of the trend predicted for n<0.1. In particular, in the region n>0.7, bending sensitivity increases with a decrease in x. In other words, bending sensitivity increases as the ratio of the upper layer thickness to the lower layer thickness decreases. This region (n>7), in fact, yields the highest predicted bending response sensitivities. The maximum predicted sensitivity of about 0.35 microns/K is at about x=0.5 and n=4. The maximum predicted sensitivity for x=0.7 is about 0.315 microns/K at n=2. And the maximum predicted sensitivity for x=1.0 is about 0.265 microns/K at n=1.

FIG. 6 presents similar information as FIG. 5 for the thermal bimorph defined above, but in FIG. 6, bending response sensitivity is presented as a function of x for several values of n. At values of x below about 1.0, bending response sensitivity increases with increasing values of n. At values of x above about 1.0, bending response sensitivity decreases with increasing values of n.

As previously disclosed, expressions [1] through [3] are valid for a non-corrugated thermal bimorph, not for the corrugated thermal bimorphs disclosed herein. Therefore, the predicted bending response sensitivity, as provided in FIGS. 5 and 6, would be different than the actual bending response of a corrugated thermal bimorph having the properties listed above. In fact, as previously indicated, the bending response of asymmetrically-corrugated thermal bimorphs is typically about 200 to 300 percent greater than the bending response of non-corrugated thermal bimorphs. It is expected, though, that the trends predicted by expressions [1] through [3] will be valid for the present corrugated thermal bimorphs and will therefore provide a reasonable starting point for the design of a sensor or actuator incorporating same. In fact, based on the results of experimentation, the bending response predicted via the expressions and depicted in FIGS. 5 and 6 can be multiplied by a factor of 2 to 3 as a starting point for design. The design can then be refined based on the results of application-specific testing.

Variations of the Asymmetric Corrugated Thermal Bimorph

The corrugated thermal bimorphs depicted in FIGS. 4A through 4I were similar to one another in that they incorporated asymmetric corrugations and included two layers, wherein the lower layer had the relatively greater thermal coefficient of expansion. But they did exhibit a number of structural differences that pertained to certain aspects of the corrugations, including corrugation depth, trench bend angle, radius of curvature, layer thickness, etc. There are, moreover, even further variations possible for a corrugated thermal bimorph. A few of these variations are described below.

The first variation of the illustrative embodiment concerns a change from asymmetric to symmetric corrugations.

FIG. 7 depicts symmetrically-corrugated thermal bimorph 722. As viewed from “upper surface” of thermal bimorph 722, each corrugation 723 comprises trench 742 and ridge 744. As viewed from the “lower” surface of thermal bimorph 722, each corrugation 723 comprises ridge 746 and trench 748. Ridge 746 and trench 742 are opposite sides of the same feature; likewise for ridge 744 and trench 748. Since the ridges and trenches are the same size, the profiles of the upper and lower surfaces are same. Symmetrically-corrugated thermal bimorph 722 is symmetric about plane A-A.

In a symmetrically-corrugated thermal bimorph, such as bimorph 722 depicted in FIG. 7, the radius of curvature of the transitions on the lower surface are the same as those on the upper surface. As a consequence, the stress enhancement that would otherwise result from the differing radius of curvature of the two surfaces of an asymmetrically-corrugated thermal bimorph is not realized. For this reason, the asymmetrically-corrugated thermal bimorph disclosed herein are expected to provide an enhanced bending response relative to the symmetrically-corrugated thermal bimorphs that are disclosed herein.

A symmetrically-corrugated thermal bimorph in accordance with a variation of the illustrative embodiment will, however, exhibit an enhanced bending response compared to a non-corrugated thermal bimorph. The reasons for this were discussed in the Summary section.

It is noted that a symmetrically-corrugated thermal bimorph is similar to an asymmetrically-corrugated thermal bimorph in terms of its response to variations such as radius of curvature and corrugation depth.

Three structural/material parameters that can be varied, and have previously been described, include:
(1) whether the corrugations in the thermal bimorph are symmetric or asymmetric;
(2) for asymmetric corrugations, which surface -the lower surface or the upper surface—has the smaller radius of curvature; and
(3) which layer—the lower layer or the upper layer—has the higher TEC.

Various configurations of a two-layer, corrugated thermal bimorph, based on variations of the three parameters itemized above, are listed in Table 1 below. All such configurations are expected to provide a difference in bending response as compared to a non-corrugated thermal bimorph, although, depending upon configuration specifics, the difference might be not be an enhancement.

TABLE 1
Configurations for Corrugated Thermal Bimorph

| CORRUGATED | | SURFACE | POSITION OF |
|---|---|---|---|
| THERMAL | | WITH | LAYER WITH |
| BIMORPH | ASYMMETRIC | SMALLER | THE |
| CONFIGU- | OR SYMMETRIC | RADIUS OF | RELATIVELY |
| RATION | CORRUGATIONS | CURVATURE | HIGHER CTE |
| 1 | Asymmetric | Lower | Lower |
| 2 | Asymmetric | Lower | Upper |
| 3 | Asymmetric | Upper | Lower |
| 4 | Asymmetric | Upper | Upper |
| 5 | Symmetric | N/A | Lower |
| 6 | Symmetric | N/A | Upper |

Configurations 1 and 4 shown in Table 1 are expected to provide the most enhancement of bending response of the six configurations listed based on the “alignment” of stress inducers. That is, in configuration 1 (which is the illustrative embodiment depicted in FIG. 4), the corrugations on the lower surface have the relatively smaller radius of curvature and the lower layer has the greater TEC. Both of these parameters dictate an upward bending response upon heating. In configuration 4, the corrugations on the upper surface have the relatively smaller radius of curvature and the upper layer has the greater TEC. Both of these parameters dictate a downward bending response upon heating. The fact that both parameters dictate the same bending response will provide these configurations with an enhanced responsiveness relative to configurations 2 and 3, in which the two parameters dictate opposite bending responses.

Since configurations 5 and 6 are symmetrically corrugated, the additive and subtractive effects due to asymmetric corrugations, as exhibited for configurations 1-4, are not present. As a consequence, configurations 5 and 6 might be expected to provide a bending response that is intermediate between configurations ¼ and ⅔.

It will be recognized that bending response of the corrugated thermal bimorphs disclosed herein can be further tailored by manipulating factors such as:
(4) The number of layers within the thermal bimorph;
(5) The precise difference in the radius of curvature for the two surfaces;
(6) The precise difference in the TEC for the various layers;
(7) The relative thickness of the various layers;
(8) Other material properties of the various layers, especially those relative to stress, such as Young's modulus;
(9) Induced stress and other processing parameters.

The effects of parameters 7 and 8 have been described in conjunction with the discussion of FIGS. 5 and 6. The effects of parameters 4 through 6 and 9 on bending response can be predicted based on theory and refined via simple experimentation.

FIG. 8 depicts a “use” variation, wherein thermal bimorph 722 having a plurality of corrugations 723 is used as an actuator, rather than a sensor as in the illustrative embodiment. In the embodiment that is depicted in FIG. 8, electrical current source 752 is electrically coupled to corrugated thermal bimorph 722 through anchor 726. As current is delivered to the bimorph, it heats and then bends, in accordance with the thermal bimorph effect. Mirrors or other elements (not depicted) that attached to corrugated thermal bimorph 722, for example, can therefore be moved based on movement of the bimorph.

In some further embodiments, heat is radiated to a corrugated thermal bimorph in a controlled manner to effect actuation.

Fabrication

The asymmetrically- and symmetrically-corrugated thermal bimorphs disclosed herein are readily fabricated using standard micromachining techniques. Typically, appropriately dimensioned and spaced grooves, etc., are formed in a substrate and then layers that are suitable for forming the thermal bimorph are conformally deposited over the grooves. This will create the alternating ridges and trenches that define the corrugations in the bimorph. Following various patterning steps, the thermal bimorph structure is “released” from the substrate, typically via an appropriate etchant. Those skilled in the art, after reading the present disclosure, will be able to fabricate corrugated thermal bimorphs in accordance with the present teachings for use in any device.

In FIG. 3B, one end of plate 318 is depicted as being separated from substrate 216 by a distance z, whereas the other end of the plate is substantially closer to the substrate. This situation results from intrinsic stresses in plate 318 that arise during manufacture. In an ideal case, plate 318 is free of such intrinsic stresses and would be parallel to substrate 216, suspended above it by support arms 320. The support arms would be substantially co-planar with plate 318, such that they too are above and parallel to substrate 216. In such a case, support arms 320 would drop down to the substrate at anchor 326. To create the separation between plate 318 and substrate 216, a sacrificial layer that has a thickness that is equal to the desired separation is deposited on the substrate. To form sensor 214, the sacrificial material would be etched away, releasing plate 318 and support arms 320.

It is to be understood that the above-described embodiments are merely illustrative of the present invention and that many variations of the above-described embodiments can be devised by those skilled in the art without departing from the scope of the invention. For example, in the illustrative embodiment, the corrugated thermal bimorphs disclosed herein provide an improved capacitive sensor. In some other embodiments, the corrugated thermal bimorph can be used to provide an optically-read sensor. Disclosure concerning optically-read sensors is provided in U.S. Pat. Nos. 6,118,124 and 6,805,839, both of which patents are incorporated by reference herein in their entirety. Also, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed:

1. An apparatus comprising a thermal bimorph, wherein said thermal bimorph comprises a plurality of corrugations, and wherein said corrugations extend fully through said thermal bimorph such that they are defined in first and second major surfaces thereof.

2. The apparatus of claim 1 wherein said corrugations are asymmetric.

3. The apparatus of claim 1 wherein said corrugations are symmetric.

4. The apparatus of claim 1 wherein a radius of curvature of said corrugations is constant.

5. The apparatus of claim 2 wherein a trench bend angle of said corrugations is about ninety degrees.

6. The apparatus of claim 1 wherein said thermal bimorph comprises:
a first layer having a first-layer thickness, a first-layer Young's modulus, and a first-layer thermal expansion coefficient; and
a second layer having a second-layer thickness, a second-layer Young's modulus, and a second-layer thermal expansion coefficient.

7. The apparatus of claim 6 wherein said first layer comprises a metal and said second layer comprises a dielectric.

8. The apparatus of claim 6 wherein said first layer comprises a metal that is selected from the group consisting of aluminum, gold, silver, lead, cadmium, manganese, zinc, tin, tantalum, and lanthanum.

9. The apparatus of claim 6 wherein said second layer comprises a dielectric that is selected from the group consisting of silicon dioxide, silicon oxynitride, silicon nitride, amorphous silicon carbide, amorphous hydrogenated silicon carbide, and amorphous silicon.

10. The apparatus of claim 6 wherein said first layer comprises aluminum and said second layer comprises an oxide of silicon.

11. The apparatus of claim 1 wherein only a portion of said thermal bimorph includes said corrugations.

12. The apparatus of claim 6 wherein said first-layer thermal expansion coefficient is greater than said second-layer thermal expansion coefficient, and further wherein:
(a) a thickness ratio, x, equals said second-layer thickness divided by said first-layer thickness; and
(b) a Young's moduli ratio, n, equals said second-layer Young's modulus divided by said first-layer Young's modulus.

13. The apparatus of claim 12 wherein said first-layer comprises a first-layer material, wherein said first-layer thermal expansion coefficient of said first-layer material is at least about 10×10⁻⁶ K⁻¹.

14. The apparatus of claim 12 wherein when n is greater than about 0.3, said first-layer thickness is greater than said second-layer thickness.

15. The apparatus of claim 12 wherein when x is about 0.7 or less, said second-layer Young's modulus is greater than said first-layer Young's modulus.

16. The apparatus of claim 1 further comprising a first support arm, wherein said first support arm comprises said thermal bimorph, and further wherein said first support arm is coupled to a substrate at a first end of said support arm.

17. The apparatus of claim 16 further comprising a plurality of said support arms, wherein each of said support arms comprises a corrugated thermal bimorph, and wherein said plurality of support arms, and said first support arm, are disposed in an array on said substrate.

18. The apparatus of claim 16 wherein said first support arm is coupled to a plate at a second end thereof, wherein said plate is supported above said substrate by said first support arm, wherein said plate and said first support arm collectively define a first thermally-sensitive cantilevered microstructure.

19. The apparatus of claim 18 wherein said plate is physically adapted to absorb radiant energy and to conduct heat resulting from said radiant energy to said thermal bimorph.

20. The apparatus of claim 18 further comprising a plurality of said thermally-sensitive cantilevered microstructures, wherein said first cantilevered microstructure and said plurality of thermally-sensitive cantilevered microstructures are disposed in an array on said substrate.

21. The apparatus of claim 20 wherein said array is a linear array having an arbitrary length.

22. The apparatus of claim 20 wherein said array is a two-dimensional array having arbitrary dimensions.

23. The apparatus of claim 18 wherein at least one of (a) said plate or (b) a material disposed on said plate is electrically conductive, thereby defining a first electrode, and wherein a region in or on said substrate below said plate is electrically conductive, thereby defining a second electrode, and further wherein said first and second electrode collectively define a first sensing capacitor.

24. The apparatus of claim 23 further comprising a plurality of sensing capacitors, wherein said first sensing capacitor and said plurality of sensing capacitors are disposed in an array on said substrate.

25. The apparatus of claim 24 wherein said apparatus further comprises a read-out integrated circuit that is electrically coupled to said sensing capacitors, wherein said readout integrated circuit senses a change in capacitance of each of said sensing capacitors and generates voltages that are proportional to said changes in capacitance.

26. The apparatus of claim 25 further comprising optics, wherein said array of sensing capacitors are disposed at a focal point of said optics.

27. The apparatus of claim 26 further comprising camera electronics, wherein said camera electronics receive and process said voltages to produce an image, wherein said apparatus is a camera.

28. The apparatus of claim 1 further comprising a power supply, wherein said power supply is electrically coupled to said thermal bimorph and delivers an electrical current thereto.

29. An apparatus comprising:
a plate, wherein said plate is physically adapted to conduct electricity and to conduct heat; and
a support arm that supports said plate, wherein said support arm comprises a thermal bimorph, wherein at least a portion of said thermal bimorph has a plurality of corrugations, and wherein said corrugations extend fully through said support arm such that they are defined in both a top surface and a bottom surface thereof, and wherein said support arm is physically adapted to conduct said heat to said plurality of corrugations.

30. The apparatus of claim 29 and further wherein said plate is physically adapted to absorb radiant energy.

31. The apparatus of claim 29 wherein:
(a) said support arm is anchored to a substrate by an anchor;
(b) said corrugations are present in a first region of said support arm and are not present in a second region of said support arm;
(c) said first region is proximal to said plate and is physically adapted to conduct heat; and
(d) said second region is proximal to said anchor and is a relatively poor conductor of heat compared to said first region.

32. The apparatus of claim 29 wherein said plate and said support arm collectively define a pixel, and wherein said apparatus comprises a focal plane array, wherein said focal plane array comprises:
a plurality of said pixels disposed in an array; and
a read-out integrated circuit electrically coupled to said pixels, wherein said read-out integrated circuit senses a change in an electrical characteristic of said pixel and generates a voltage that is proportional to said change.
